(19) United States
(12) Patent Application Publication
(10) Pub. No.: US 2009/0002715 A1
(43) Pub. Date: Jan. 1, 2009

(54) Coordinate measuring machine with vibration decoupling and method for vibration decoupling of a coordinate measuring machine

(75) Inventors: Uwe Goetz, Braunfels-Neukirchen (DE); Guenter Schieferstein, Huettenberg (DE)

Correspondence Address: C. Richard Lohrman, Esq.;Simpson & Simpson, PLLC, 5555 Main Street, Williamsville, NY, 14221-5406, US

(73) Assignee: Vistec Semiconductor Systems GmbH, Weilburg (DE)

(21) Appl. No.: 12/215,272

(22) Filed: Jun. 26, 2008

(30) Foreign Application Priority Data
Jun. 27, 2007 (DE) 10 2007 030 202.0

(51) Int. Cl. G01B 11/03

(52) U.S. Cl. 356/500

(57) ABSTRACT

A coordinate measuring machine (1) with vibration decoupling is disclosed, and a method for vibration damping or decoupling is realized. There is provided a measurement table (20) movable in the X-coordinate direction and in the Y-coordinate direction, which is essentially movable in one plane (25a). A controller (16) is connected to the vibration dampers (26) and the measurement table (20), wherein the controller (16) determines the influence of the measurement table (20) on the vertical position alterations of the coordinate measuring machine (1) from an impending or predetermined movement path (30) of the measurement table (20) and controls the vibration dampers (26) such that the position alterations caused by the influence of the measurement table (20) are compensated.

### CROSS REFERENCE TO RELATED APPLICATIONS

This patent application claims priority of German Patent Application No. 10 2007 030 202.0, filed on Jun. 27, 2007, the application is incorporated herein by reference, in its entirety.

### FIELD OF THE INVENTION

The present invention relates to a coordinate measuring machine with vibration decoupling. In particular, the invention relates to a coordinate measuring machine with vibration decoupling, wherein the coordinate measuring machine carries a measurement table movable in the X-coordinate direction and in the Y-coordinate direction, which is essentially movable in one plane. The coordinate measuring machine rests on at least three vibration dampers.

The invention further relates to a method for vibration decoupling of a coordinate measuring machine. In particular, the invention relates to a method for vibration decoupling of a coordinate measuring machine, wherein the coordinate measuring machine carries a measurement table movable in the X-coordinate direction and in the Y-coordinate direction, which is essentially moved in one plane. The coordinate measuring machine rests on at least three vibration dampers.

### BACKGROUND OF THE INVENTION

A coordinate measuring device of the category-defining type is known from the German published application DE 10 2004 023 739. A measurement table is arranged on a granite block defining a plane in which the measurement table is movable in the X-coordinate direction and in the Y-coordinate direction. The measurement table itself carries the mask or substrate to be inspected. The granite block of the coordinate measuring machine rests on at least three vibration dampers. However, the suggested solution does not allow compensating forces introduced into the coordinate measuring machine by the movement of the measurement table by corresponding damping so that the plane in which the measurement table moves is not affected.

### SUMMARY OF THE INVENTION

It is the object of the present invention to present a coordinate measuring machine which includes forces caused by the table movement in the damping of the coordinate measuring machine.

This object is achieved by a coordinate measuring machine with vibration decoupling, comprising: a measurement table movable in the X-coordinate direction and in the Y-coordinate direction, wherein the measurement table is substantially movable in one plane, at least three vibration dampers (decouplers) on which the coordinate measuring machine rests, a controller connected to the vibration dampers and the measurement table, wherein the controller determines the influence of the measurement table on the position alterations of the coordinate measuring machine from an impending or predetermined movement path of the measurement table, wherein the vibration dampers are controllable such that the position alterations caused by the influence of the measurement table are compensated and the plane in which the measurement table moves is thus stabilized. By vibration decoupling is meant the apparatus and/or method used to reduce or eliminate the effect of vibration on the movement of the measurement table and plane from an impending or predetermined path.

It is a further object of the present invention to suggest a method with which the forces caused by the table movement do not have any influence on the plane in which the measurement table moves.

This object is achieved by a method for vibration decoupling of a coordinate measuring machine, wherein the coordinate measuring machine carries a measurement table having a plane movable in a X-coordinate direction and a Y-coordinate direction, and wherein the coordinate measuring machine rests on at least three vibration dampers, comprising the steps of: connecting a controller to the vibration dampers and the measurement table, wherein the influence of the measurement table on the position alterations of the plane in which the measurement table moves is determined by the controller from an impending or predetermined movement path of the measurement table; and controlling the vibration dampers correspondingly so that the position alterations of the plane caused by the influence of the measurement table are compensated.

It is advantageous for the present invention if the coordinate measuring machine comprises vibration decoupling. The coordinate measuring machine carries a measurement table movable in the X-coordinate direction and in the Y-coordinate direction, which is essentially movable in one plane. The coordinate measuring machine rests on at least three vibration dampers. A controller is connected to the vibration dampers and the measurement table, wherein the controller determines the influence of the measurement table on the position alteration of the coordinate measuring machine from the impending movement of the measurement table. The vibration dampers are controllable such that the position alterations of the plane caused by the influence of one or more predetermined movements of the measurement table may be compensated and thus the plane in which the measurement table moves is stabilized.

The vibration damping may be actively pneumatic. The vibration damping may also be implemented to be actively piezoelectric. In both cases, this active vibration damping is connected to the controller.

There may be provided a database in which the effect of the movement of the measurement table and its compensation by the active damping are stored. The values for the compensation of a position alteration of the plane in which the measurement table moves, which is caused by the movement of the measurement table, may be retrieved from the database.

The movement of the measurement table is realized by trajectories along which the measurement table moves in the plane. Based on the knowledge of the respective trajectory \vec{r}(t) of the measurement table, the resulting forces exerted on the vibration dampers may be calculated. The current compensation forces may also be determined from the resulting forces.

The method for vibration decoupling of a coordinate measuring machine has a measurement table movable in the X-coordinate direction and in the Y-coordinate direction, which is substantially moved in one plane, although there is some movement in the Z direction plane. The coordinate measuring machine rests on at least three vibration dampers. A controller is connected to the vibration dampers and the measurement table, wherein the influence of the measurement table on the position alterations of the plane in which the measurement table moves is determined by the controller from an impending or predetermined movement of the measurement table. The position alterations of the plane caused by the influence, of the measurement table are compensated thereby.

Further advantageous embodiments of the invention may be found in the dependent claims.

### BRIEF DESCRIPTION OF THE DRAWINGS

In the following, embodiments will explain the invention and its advantages in more detail with reference to the accompanying figures.

FIG. 1 schematically shows a coordinate measuring device, wherein the vibration dampers are connected to a controller or a control computer;

FIG. 2 shows a schematic top view of the plane in which the measurement table moves; and

FIG. 3 shows a schematic bottom view of the plane in which the measurement table moves, and an arrangement of three vibration dampers, each connected to the control unit or the control computer.

### DETAILED DESCRIPTION OF PREFERRED EMBODIMENTS OF THE INVENTION

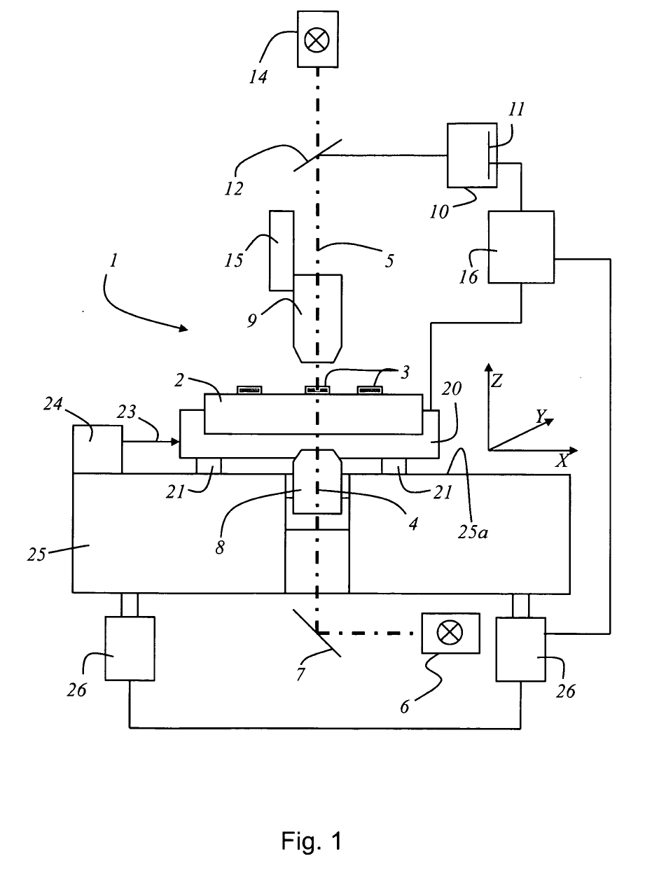

A coordinate measuring device 1 is shown in FIG. 1. The coordinate measuring device 1 has a measurement table 20 movable in the X-coordinate direction and in the Y-coordinate direction. The measurement table 20 is positioned on air bearings 21 for movement. In the embodiment shown, a granite block 25 is provided having a plane 25a in which the measurement table 20 is movable. The use of a granite block 25 is only one option and is not to be considered as a limitation of the invention. Those skilled in the art will understand that the plane 25a in which the measurement table 20 is movable may also be formed by other elements.

The plane 25a or the granite block 25 rests on at least three vibration dampers 26. The position of the measurement table 20 is measured within the plane 25a, that is substantially, but not totally, in the X and Y directions, by means of a laser interferometer system 24 emitting a measurement beam 23. The measurement table 20 itself carries a substrate or a mask 2 having structures 3 on a surface. For the incident light illumination means of the mask, an incident light illumination means 14 is provided that emits an illumination light beam along the optical axis 5. Likewise, a transmitted light illumination means 6 is provided for the transmitted light illumination of the mask 2. In the embodiment shown, the light from the transmitted light illumination 6 is directed via a deflecting mirror 7 to a condenser 8 arranged in the transmitted light illumination axis 4. With the help of the measurement objective 9, the light of the incident light illumination means 14 and the light of the transmitted light illumination means 6 is collected and directed to a camera 10 by means of a semi-transparent mirror 12. The measurement objective 9 is arranged to be displaceable in the Z-coordinate direction by a displacing means 15, so that focusing on the individual structures 3 on the surface of the mask 2 may be performed with the objective.

The camera 10 has a detector connected to a computer 16. The computer thus generates a digital image from the acquired image data. The computer 16 is further also connected to the measurement table 20 and each vibration damper 26. This allows active vibration damping. The vibration damping may be implemented to be actively pneumatic or actively piezoelectric.

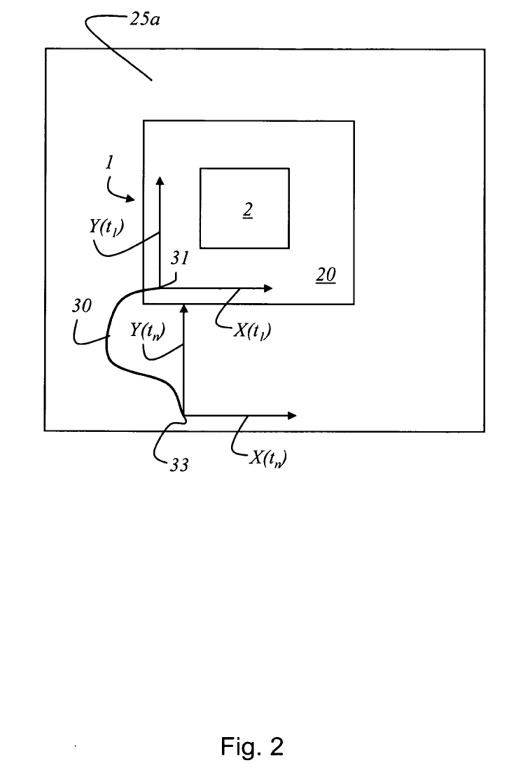

FIG. 2 shows a schematic view of the plane 25a in which the measurement table 20 with the mask 2 is moveably arranged. The measurement table 20 executes a movement path 30 within the plane 25a. The movement path 30 starts at the point of origin of the coordinate system of the measurement table 20. The point of origin is defined by the coordinates X(t₁), Y(t₁). The movement path 30 ends at an endpoint within the coordinate system of the measurement table, which is defined by X(tₙ), Y(tₙ). There are several ways to compensate for the influence of the movement of the measurement table 20 on the position of the plane 25a. One possibility is to store several movement paths and the forces exerted on the position of the plane 25a by the movement of the measurement table 20 along each of the paths in a database. When the measurement table is moved from one measurement position to the next one, similar movement paths and their force effects may be predicted from the database based on the retrieved data. A corresponding compensation is performed by the computer 16. An alternate compensation possibility is to calculate the resulting forces based on the current trajectory or movement path 30 of the measurement table 20 when it moves from a starting point 31 to an end point 33. This calculation is done by the computer 16. The compensation of a position alteration in the vertical or Z direction of the plane 25a caused by the movement of the measurement table is also calculated therefrom. The calculation of the compensation forces is thus performed up-to-date and may thus be determined for any movement path 30.

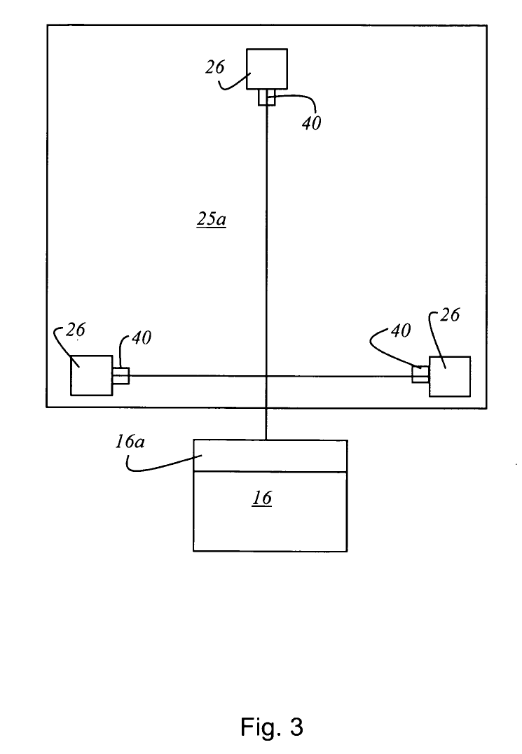

FIG. 3 schematically shows a bottom view of the plane 25a. The plane 25a rests on at least three vibration dampers 26. Each of the vibration dampers is connected to the computer 16. Each of the vibration dampers 26 is connected to an actuator 40. With the help of the actuator 40, the active vibration damping or decoupling of the plane 25a is achieved. The control of the active vibration damping is performed by the computer 16. The computer 16 is further provided with a database in which the effect of the movement of the measurement table 20 and its compensation by the active damping are stored. Depending on the movement of the measurement table 20, the values for the compensation of a position alteration of the plane 25a in which the measurement table 20 moves, which is caused by the movement of the measurement table, may thus be retrieved from the database.

The actuators 40 equipped with the vibration dampers 26 may thus provide actively pneumatic or actively piezoelectric vibration damping. The active vibration damping is connected to the controller or the computer 16. It is also possible that the measurement table 20 is moved along various movement patterns, wherein, in parallel, the position alteration of the plane 25a in which the measurement table 20 moves, which is caused by the movement, is recorded. Then the effects of the movement of the measurement table 20 are stored with their compensation for the active damping in the database 16a. For the compensation, the position alterations of the plane 25a in which the measurement table 20 moves, which are caused by the movement of the measurement table 20, are finally retrieved from the database 16a and passed on to the active vibration decoupling.

It is also possible that the movements of the measurement table 20 are realized by trajectories along which the measurement table 20 moves in the plane 25a. Based on the knowledge of the respective trajectory \vec{r}(t) of the measurement table, the resulting forces exerted on the vibration dampers 26 may be determined by the computer 16. The acting current compensation forces may also be determined therefrom. The corresponding compensation forces are then conveyed to the active vibration damping by means of the controller or computer 16, so that the position alterations of the plane 25a in which the measurement table 20 moves, which are caused by the movement of the measurement table 20, do not have any influence on the position of this plane 25a. A database 16a or a memory from which the required data are retrieved is associated with the computer 16.

The invention has been described considering a particular embodiment. However, someone skilled in the art will understand that modifications and changes may be made without departing from the scope of the following claims.

What is claimed is:

1. A coordinate measuring machine with vibration decoupling, comprising: a measurement table movable in the X-coordinate direction and in the Y-coordinate direction, wherein the measurement table is substantially movable in one plane, at least three vibration dampers on which the coordinate measuring machine rests, a controller connected to the vibration dampers and the measurement table, wherein the controller determines the influence of the measurement table on the position alterations of the one plane of the coordinate measuring machine from an impending movement path of the measurement table, wherein the vibration dampers are controllable such that the position alterations on the one plane caused by the influence of the measurement table are compensated and the one plane in which the measurement table moves is thus stabilized.

2. The coordinate measuring machine of claim 1, wherein the vibration damping is implemented to be actively pneumatic or actively piezoelectric and the active vibration damping is connected to the controller.

3. The coordinate measuring machine of claim 1, wherein a database is provided in which the effects of the movement path of the measurement table and their compensation by the active damping are stored.

4. The coordinate measuring machine of claim 3, wherein the values for the compensation of a position alteration of the plane in which the measurement table moves, wherein said position alteration is caused by the movement path of the measurement table, may be retrieved from the database.

5. The coordinate measuring machine of claim 4, wherein the movement path of the measurement table is realized by several trajectories along which the measurement table moves in the one plane.

6. The coordinate measuring machine of claim 5, wherein the resulting forces exerted on the vibration dampers are calculated based on the knowledge of the respective trajectory \vec{r}(t) of the measurement table, wherein the acting current compensation forces may be determined.

7. A method for vibration decoupling of a coordinate measuring machine, wherein the coordinate measuring machine carries a measurement table having a plane movable in a substantially X-coordinate direction and a Y-coordinate direction, which is essentially moved in one plane, and wherein the coordinate measuring machine rests on at least three vibration dampers, comprising the steps of:
connecting a controller to the vibration dampers and the measurement table, wherein the influence of the measurement table on the position alterations of the plane in which the measurement table moves is determined by the controller from an impending movement path of the measurement table; and
controlling the vibration dampers correspondingly so that the position alterations of the plane caused by the influence of the measurement table are compensated.

8. The method of claim 7 wherein the vibration damping is regulated in an actively pneumatic or actively piezoelectric way and the active vibration damping is connected to the controller.

9. The method of claim 7, wherein several different movement patterns of the measurement table are traced, while the position alteration of the plane in which the measurement table moves, which is caused by the movement, is recorded, and that the effects on the plane of the movements of the measurement table and their compensation by the active damping are stored in a database.

10. The method of claim 9, wherein the values for the compensation of a position alteration of the plane in which the measurement table moves, which is caused by the movement of the measurement table, are retrieved from the database and passed on to the active vibration decoupling method.

11. The method of claim 10, wherein the movements of the measurement table are realized by trajectories along which the measurement table moves in the plane.

12. The method of claim 11, wherein the resulting forces exerted on the vibration dampers are calculated based on the knowledge of the respective trajectory \vec{r}(t) of the measurement table, and wherein the acting current compensation forces are determined.
